(19) United States
(12) Patent Application Publication
(10) Pub. No.: US 2011/0248465 A1
(43) Pub. Date: Oct. 13, 2011

(54) REAR WHEEL SUSPENSION, THE COIL SPRING OF WHICH HAS A TILTED LINE OF ACTION OF FORCE

(75) Inventors: Andreas Carlitz, Stolberg (DE); Theo Kueppers, Waldfeucht (DE); Jens Glorer, Pulheim (DE)

(73) Assignee: FORD GLOBAL TECHNOLOGIES, LLC, Dearborn, MI (US)

(21) Appl. No.: 13/083,657

(22) Filed: Apr. 11, 2011

(30) Foreign Application Priority Data
Apr. 12, 2010 (EP) 10159613.8

(51) Int. Cl. B60G 11/00

(52) U.S. Cl. 280/124.164

(57) ABSTRACT

The invention relates to a rear wheel suspension, which has a spring, preferably embodied as a coil spring that has a geometric spring center line and a line of action of force, the coil spring being supported in an upper and a lower spring mount. In order to reduce the forces imposed on structural elements of the rear wheel suspension, the proposal is that the spring be embodied and arranged in such a way that the line of action of force thereof has an amount of tilt during an inward deflection which is different from an amount of tilt during an outward deflection.

### CROSS-REFERENCE TO RELATED APPLICATIONS

This application claims foreign priority benefits under 35 U.S.C. §119(a)-(d) to EP 10159613.8 filed Apr. 12, 2010, which is hereby incorporated by reference in its entirety.

### TECHNICAL FIELD

The invention relates to a rear wheel suspension, which has a spring, in the preferred embodiment as a coil spring, that has a geometric spring center line and a line of action of force, the coil spring being supported in an upper and a lower spring mount, in which a wheel on the outside of the bend or the associated coil spring is deflected inward during cornering, and a wheel on the inside of the bend or the associated coil spring is deflected outward.

### BACKGROUND

Rear wheel suspensions of this kind are known in the form of semi-independent axles, for example.

DE 10 2004 058 698 B3 (corresponding to U.S. Pat. No. 7,392,978) describes a wheel suspension or active chassis, comprising a vehicle body, a wheel movably attached to the latter via a link arrangement and having a hub carrier and at least one helical compression spring, which is supported at one end on the vehicle body and at the other end on the hub carrier or the link arrangement. The spring stiffness of the vehicle body support relative to a contact point of the wheel is supposed to be modifiable in a controlled manner. Here, use is made of a helical compression spring arrangement, the line of action of force of which deviates from the geometric spring center line. The line of action of force is adjusted spatially relative to the geometric center line by means of turning means. Thus, it is possible inter alia to bring about load compensation at the rear axle of the vehicle when the motor vehicle is loaded. In other words, the level of the motor vehicle is adjusted at the rear of the latter when the line of action of force is turned spatially relative to the spring center line. The essential point in DE 10 2004 058 698 B3 is that the helical compression springs on each side of the vehicle can be controlled separately, that is to say can also be actively controlled. In one illustrative embodiment, DE 10 2004 058 698 B3 describes a situation in which a helical compression spring as part of a McPherson strut, in other words a front wheel suspension, can be set obliquely. However, this merely solves the problem of keeping damaging forces away from the guide element or piston of the suspension strut, something which is also disclosed in DE 699 08 502 T2 (corresponding to U.S. Pat. No. 6,199,882). DE 10 2004 058 698 B3 furthermore teaches that the helical compression springs in the rear wheel suspension are arranged vertically.

In DE 699 08 502 T2 (=EP 0 976 591 B1), a description is given of a front wheel suspension which has a suspension strut and a helical compression spring surrounding the latter, which is secured in a lower seat on the suspension strut and in an upper seat on the vehicle body. The helical compression spring has a turn axis which is curved with a defined radius of curvature in the unloaded condition. The helical compression spring is embodied in a C shape or is held in a C shape between the two mounting points. The intention is in this way to achieve a reduction in the lateral force acting on the guiding portion of the suspension strut and the piston thereof.

WO 2009/124658 (corresponding to US 20100314933) discloses a counter-steering vehicle rear axle which, under the action of a lateral force on the wheel on the outside of a bend, said wheel being secured on a hub carrier, induces a rotary motion of said hub carrier about a virtual axis of spread in the direction of toe-in, the hub carrier being supported via support elements on a longitudinal member extending substantially in the longitudinal direction of the vehicle. WO 2009/124658 takes as its starting point semi-independent axles, which can have a tendency to over-steer under the influence of lateral force, that is to say, for example, during cornering, for which reason the intention is to make available an axle which meets general strength requirements. For this purpose, WO 2009/124658 proposes that two support elements are provided in each case above and below a wheel center, these support elements being flexible in torsion but resistant to bending, and, like the virtual axis of spread, being tilted substantially to the same degree with respect to the vertical direction in a lateral projection, with an upper connecting support element, which extends substantially inward in the transverse direction of the vehicle, being supported at one end on the hub carrier and at the other end on an upper torsion support element, with the upper torsion support element being supported by its other end on the axle body, while a lower connecting support element, which extends substantially in the vertical direction, is supported at one end on the hub carrier and at the other end on a lower torsion support element, with the lower torsion support element being supported on the axle body by its other end.

Especially when the motor vehicle is cornering, considerable lateral forces are effective at the wheel on the inside of the bend and on the outside, and these have to be absorbed by the rear wheel suspension or the components thereof. It is known that these lateral forces are absorbed by appropriate mounts or support bushings, and, on the one hand, these should be stiff enough to avoid over-steer. On the other hand, the mounts or support bushings should be flexible enough to enable appropriate ride comfort to be achieved. In order to reduce a toe-out effect in the rear wheel suspension, provision can be made to arrange the mounts or support bushings with a tilt, as can be seen, for example, in FIG. 1 relating to the prior art.

FIG. 1 shows a rear wheel suspension 1 embodied as a semi-independent axle. The rear wheel suspension 1 comprises two trailing longitudinal swing arms 2, which are connected at the front, close to the axis of rotation thereof, by a welded-in profile 3. The profile 3 typically has a U- or T-shaped cross section and is dimensioned in such a way that it twists during inward and outward deflection on one side and acts as a stabilizer. In the case of the twist beam axle, which is of similar construction, the longitudinal links are connected approximately in the middle by a downwardly open U profile with welded-in torsion tube. If the profile connects the longitudinal links at the end thereof, the term “torsion crank axle” is used.

A toe-out effect results from the compliance of the structural elements of the wheel suspension under the action of lateral forces during cornering. However, the compliance of the structural components and a toe-correcting movement of the axle lead to an unresponsive ride which is felt to be a disadvantage by the driver of the vehicle and the passengers in the vehicle. Hence, the individual components or structural elements of the rear wheel suspension must be designed to counter this compliance, i.e. to counter this yielding, that is to say their dimensions must be adapted. This entails an increase in weight, which has a disadvantageous effect on the weight of the vehicle, more specifically of the rear wheel suspension, if the thicknesses of material have to be adapted accordingly, for example. However, an increase in weight also means an increase in fuel consumption, for example.

Another known practice, however, is additionally to provide what is referred to as a Watt linkage in the semi-independent axle, as disclosed in DE 10 2008 045 817 A1, for example. With the additional Watt linkage, the support bushings can be made softer in order to increase ride comfort and lateral forces can be absorbed by the additional Watt linkage. However, the additional Watt linkage imposes an additional weight on the vehicle, more specifically the rear wheel suspension, even if the design of individual components of the rear wheel suspension can be adapted accordingly. Moreover, the additional Watt linkage requires additional installation space, and there may be limits on the latter. Thus, for example, compromises with regard to the space available in a trunk, that is to say, for example, as regards the arrangement of a spare wheel, have to be made. In addition to the additional components of the Watt linkage which have to be fitted, an additional acoustic path is also produced, and passengers in the vehicle may well find any noises which arise to be troublesome.

It is therefore the underlying object of the invention to improve a rear wheel suspension of the type stated at the outset in such a way, by simple means, that said suspension is improved, in terms of the weight and the compliance thereof for example, without the need to use additional components and, as a result, the required installation space is not increased either.

### SUMMARY

It is therefore the underlying object of the invention to improve a rear wheel suspension of the type stated at the outset in such a way, by simple means, that said suspension is improved, in terms of the weight and the compliance thereof for example, without the need to use additional components and, as a result, the required installation space is not increased either.

According to the invention, the object is achieved by a rear wheel suspension having the features of claim 1, the spring being embodied and arranged in such a way in the preferred embodiment as a coil spring that the line of action of force thereof has an amount of tilt during an inward deflection which is different from an amount of tilt during an outward deflection. The amount of tilt during an inward deflection is preferably greater than in the case of an outward deflection. In other words, the spring is arranged and embodied in such a way that the line of action of force thereof during an inward deflection is tilted further toward the horizontal than in the case of an outward deflection, and, in both situations, i.e. both at the wheel on the inside of the bend and on the outside of the bend, the line of action of force is nevertheless tilted with respect to the horizontal and to the vertical. Thus, during an outward deflection, the line of action of force becomes more erect, the distance between the upper spring mount and the lower spring mount increasing during an outward deflection. Of course, the wheel on the inside of the bend, more specifically the spring situated there, is deflected outward and, during cornering, the wheel on the outside of the bend, more specifically the spring situated there, is simultaneously deflected inward, with the result that the amounts of lateral force components produced by the spring and indeed also by the wheels on the inside of the bend are less than those on the outside of the bend, more details thereof being given below.

In the text which follows, the spring in its preferred embodiment as a coil spring will be denoted as such.

The line of action of force has an upper piercing point and a lower piercing point. With the upper piercing point, the line of action of force intersects the upper spring mount. With the lower piercing point, the line of action of force intersects the lower spring mount. With respect to the spring center line, the upper and lower piercing points are thus arranged on opposite sides of the spring center line when the coil spring is deflected inward or outward, for example.

It is advantageous if the line of action of force of the coil spring is arranged with a tilt, with the result that, as the vehicle corners, a lateral force is produced, counteracting the lateral forces of the respective wheel. Since the coil spring generates and absorbs this counteracting lateral force, the dimensions of components or structural elements of the rear wheel suspension can be reduced since they can be designed to resist correspondingly lower loads. In this way, it is advantageously possible to achieve a reduction in weight which has a direct effect with respect to lower fuel consumption. Moreover, no additional components, e.g. a Watt linkage, are required, and, as a result, there is no disadvantageous effect on the installation space required either since, according to the invention, the coil spring in its simplest embodiment is merely mounted with a tilt or, more specifically, the coil spring is arranged in such a way that the line of action of force thereof is arranged with a tilt in order to generate lateral forces that counteract the lateral forces of the respective wheel.

In an advantageous embodiment, it is accordingly possible simply to provide for the coil spring of the rear wheel suspension to be mounted with a tilt between the upper and the lower spring mount thereof, giving the correspondingly tilted line of action of force. It is preferred if the upper end of the coil spring is oriented away from the wheel and the lower end thereof is oriented in a direction toward the wheel. It is also conceivable, however, to embody the upper and the lower spring mount in a corresponding manner, thus ensuring that the coil spring or the line of action of force thereof is tilted.

It is expedient if the coil spring is arranged and embodied in such a way that, with respect to the lower piercing point, the upper piercing point is arranged closer to the geometric spring center line than the lower piercing point when the coil spring is deflected outward or inward, for example, thus producing an asymmetric pressure distribution which produces lateral forces that counteract the lateral forces of the wheels.

In a preferred embodiment, the rear wheel suspension is embodied as a semi-independent axle, each (rear) wheel being assigned at least one coil spring, the lines of action of force of which, with respect to the respective upper piercing point thereof through the respective upper spring mount, are oriented toward one another. Thus, provision is expediently made for the respective coil springs of the respective wheel of the rear wheel suspension or semi-independent axle to be tilted in opposite directions with respect to a vertical axis, i.e. for the respective upper ends thereof to be oriented toward one another, but preferably to have an equal amount of tilt when the coil spring is neither being deflected inward nor outward.

The coil spring is usually guided by a guide element in the lower and the upper spring mount thereof. One known option is to embody the guide element as a pin which engages in the lower and the upper spring lug. In the invention, by contrast, provision can be made to have the guide element engage on an outer circumference of the coil spring. In this way, the lower spring plate or lower spring mount, for example, can advantageously be set at an angle. In this embodiment, the lower spring plate drifts more or less inward on the outside of the bend during cornering, as a result of which the distance between the upper spring mount and the lower spring mount decreases on the outside of the bend and therefore the coil spring is compressed, this having the effect that the line of action of force is tilted to an increasing extent in the direction of the horizontal. In this way, it is possible to generate lateral forces that counteract the lateral forces of the wheel.

Another advantageous effect of the slanting spring plate can be regarded as the fact that a shift in the pressure point in the lower spring lug relative to the geometric spring center line is increased.

The invention provides a rear wheel suspension, e.g. a semi-independent axle, in which the coil spring has a tilted line of action of force in order to generate lateral forces that counteract the lateral forces of the respective wheels during cornering. As a result, the structural elements of the rear wheel suspension or semi-independent axle can be designed for lower loads since the coil spring has the effect that forces which it absorbs are kept away from the structural elements of the rear wheel suspensions, and this has an advantageous effect in terms of a lower weight without the need to use additional components. Moreover, by means of the measure according to the invention a rear wheel suspension is achieved which has a lower compliance, ensuring that the vehicle itself responds more directly. Of course, this can also be achieved with an additional Watt linkage, for example, but this produces additional loads and requires additional installation space, which runs contrary to the aim of the invention.

### BRIEF DESCRIPTION OF THE DRAWINGS

FIG. 1 shows a rear wheel suspension according to the prior art. Further advantageous embodiments of the invention are disclosed in the subclaims and in the following description of the figures. In the drawing:

FIG. 2 shows a rear wheel suspension according to the invention in a schematic perspective view,

FIGS. 3 and 4 show reactions of the rear wheel suspension on the side of the rear wheel suspension on the outside and the inside of the bend, respectively, in a schematic view,

FIG. 5 shows a detail of the rear wheel suspension according to FIG. 1 during an outward deflection,

FIG. 6 shows a detail of the rear wheel suspension according to FIG. 1 during an inward deflection,

FIGS. 7 to 12 show results for a known rear wheel suspension in comparison with a rear wheel suspension according to the invention, more specifically respective graphs of the wheel motion with respect to lateral forces, lateral offset, toe and camber.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the various figures, identical parts are always provided with the same reference signs, for which reason said parts are also generally described only once.

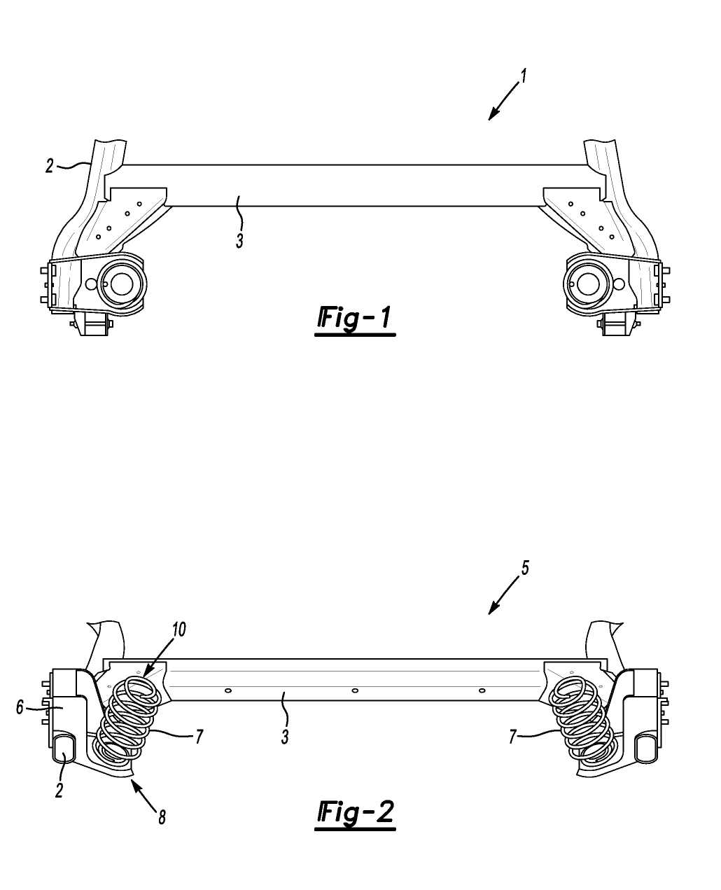

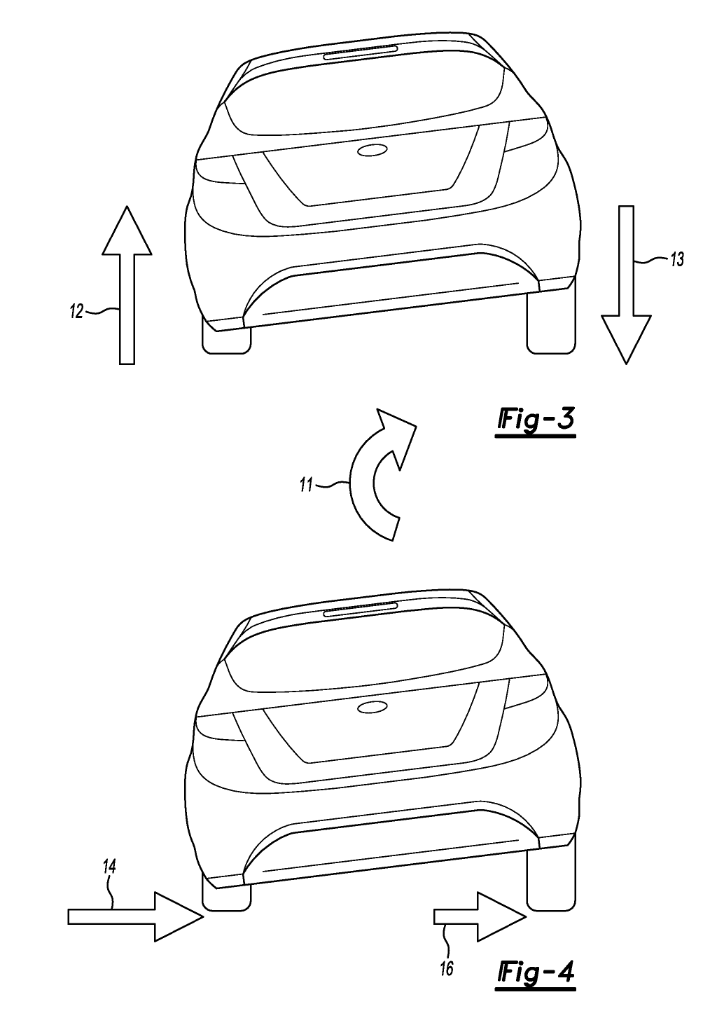

FIG. 2 shows a rear wheel suspension 5 which, as described in relation to FIG. 1 according to the prior art, is embodied as a semi-independent axle 5 by way of example. The semi-independent axle 5 has a longitudinal swing arm 2 assigned to each hub carrier 6. The longitudinal swing arms 2 are connected to one another by a profile 3. The longitudinal swing arms 2 and the profile 3 or structural elements of the rear wheel suspension 5 can have a very wide variety of configurations but this will not be explored in further detail.

Also arranged on the longitudinal swing arms 2 are support bushings, which are not shown.

Each longitudinal swing arm 2 is assigned a spring 7, in the preferred embodiment a coil spring 7, which is supported at one end, i.e. at its low end 8, on the respective longitudinal swing arm 2 and, at the other end, i.e. at its upper end 10, on a vehicle body (not shown), for example. The spring 7 is referred to below as coil spring 7.

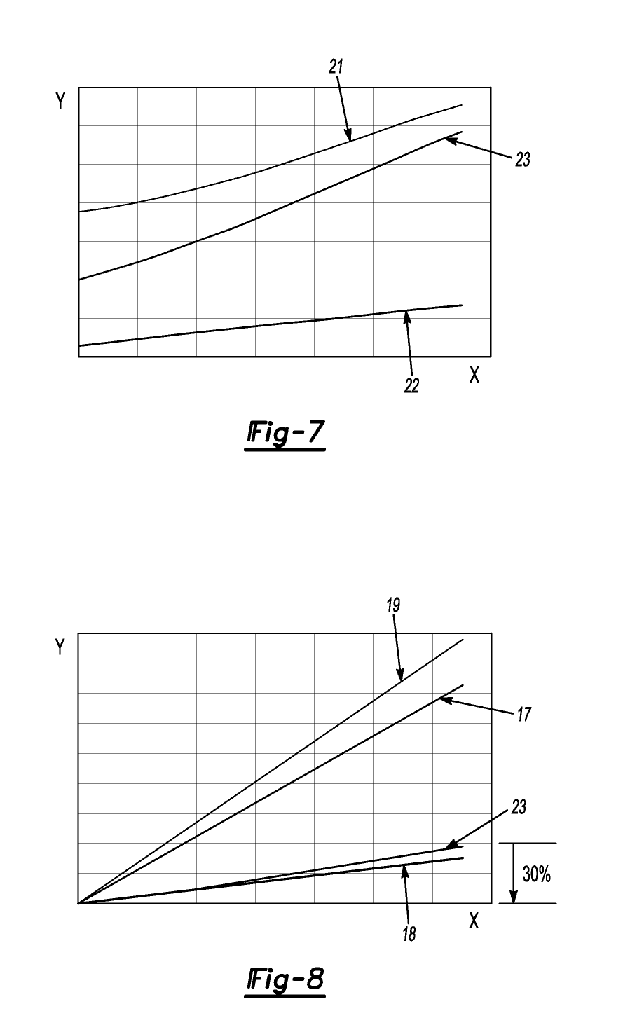

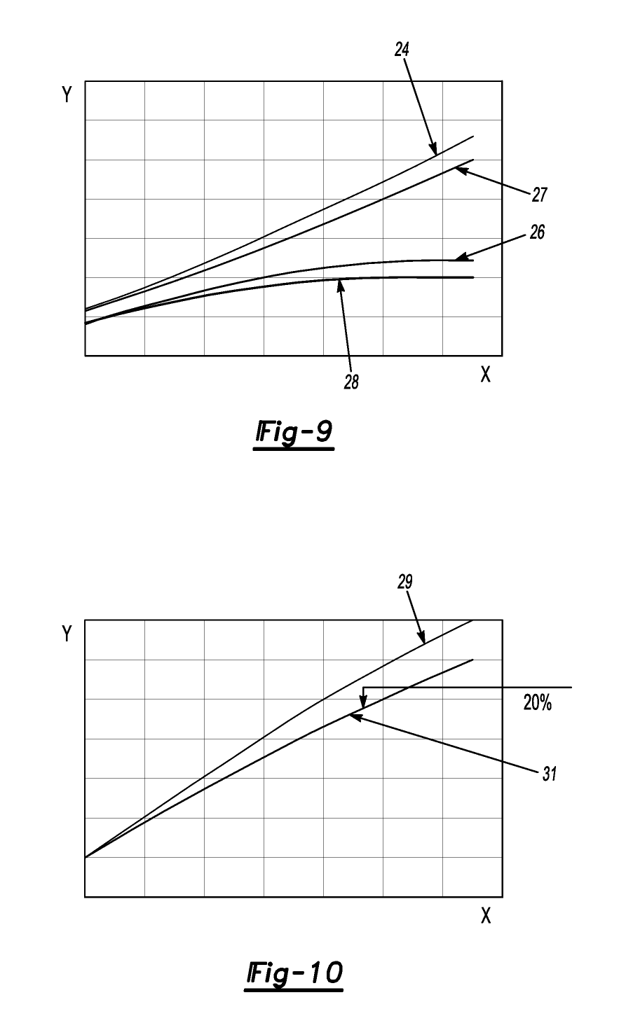

The essential point is that the respective coil spring 7 is arranged in such a way that the line of action of force 9 thereof (see FIGS. 5 and 6) has an amount of tilt during an inward deflection (FIG. 6) which is different from an amount of tilt during an outward deflection (FIG. 5). The amount of tilt of the line of action of force 9 during an inward deflection is preferably greater than in the case of an outward deflection. As illustrated by way of example, the coil springs 7 on each side of the vehicle are oriented toward one another in opposite directions, the upper end 10 in each case being tilted inward, i.e. away from the hub carrier 6 (FIG. 2).

The inward deflection and outward deflection illustrated in FIGS. 5 and 6 is illustrated using the same side of the rear wheel suspension 5. Of course, the opposite side of the rear wheel suspension 5 is deflected either outward or inward. When FIGS. 5 and 6 are compared, however, it is clearly apparent that the amount of tilt of the line of action of force 9 during inward deflection is greater than during outward deflection, and this also applies similarly to the opposite side (not shown), of the oppositely oriented coil spring 7.

The coil spring 7 illustrated in the figures has a cylindrical outer circumference. Of course, it is also possible for the coil spring 7 to be bent when mounted, i.e. to be embodied in a C shape or S shape or to be mounted in a corresponding way, for example. It is also conceivable to provide different wire thicknesses in relation to the inner and outer sides, for example. Of course, these illustrative embodiments are not intended to have a limiting effect. The essential point is that, during an inward or outward deflection, the coil spring 7 produces lateral forces that counteract the lateral forces of the wheels, thus relieving the load on the structural elements of the rear wheel suspension 5 by this amount corresponding to the “lateral spring force” without the need for additional components.

The essential point is, therefore, that a lateral force is generated by means of the tilted line of action of force 9, counteracting the lateral forces of the wheels when the vehicle is cornering, thus enabling the structural elements of the rear wheel suspension or semi-independent axle to be dimensioned with respect to reduced loads in comparison with a line of action of force 9 which is not arranged with a tilt.

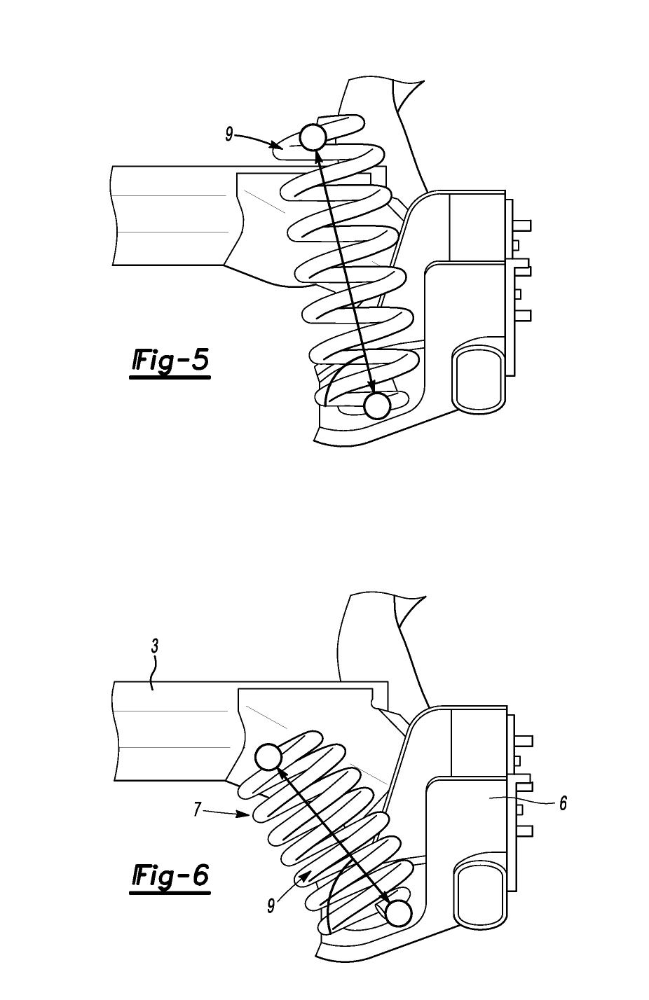

FIGS. 3 and 4 show, by way of example, the reaction of the rear wheel suspension 5 when the vehicle is cornering (cornering arrow 11).

In FIG. 3, it is apparent that the wheel on the outside of the bend is being deflected inward (left hand side of the picture), while the wheel on the inside of the bend is being deflected outward (right hand side of the picture). The inward and outward deflection is apparent from opposing arrows 12 (inward deflection) and 13 (outward deflection). The respective wheel can execute a wheel travel of several millimeters, e.g. in each case of from 0 to 65 mm. In FIG. 4, the lateral forces arising at the wheels are represented by arrows 14 and 16. On the outside of the bend (left hand side of the picture), the arrow 14 is drawn bigger than the arrow 16 on the inside of the bend since the lateral forces which arise on the outside of the bend are greater than those which arise on the inside of the bend.

The lateral forces which arise at the wheels in a conventional semi-independent axle are depicted in the graph shown in FIG. 8. Graph line 17 shows the lateral forces of the wheels on the outside of the bend (inward deflection). Graph line 18 shows the lateral forces of the wheels on the inside of the bend (outward deflection). The X axis represents the wheel travel. The Y axis represents the lateral forces. Graph line 19 shows the sum of the two lateral forces (inside/outside of the bend). With increasing wheel travel, the respective lateral force of the wheels and hence also the sum of the lateral forces increases (graph line 19).

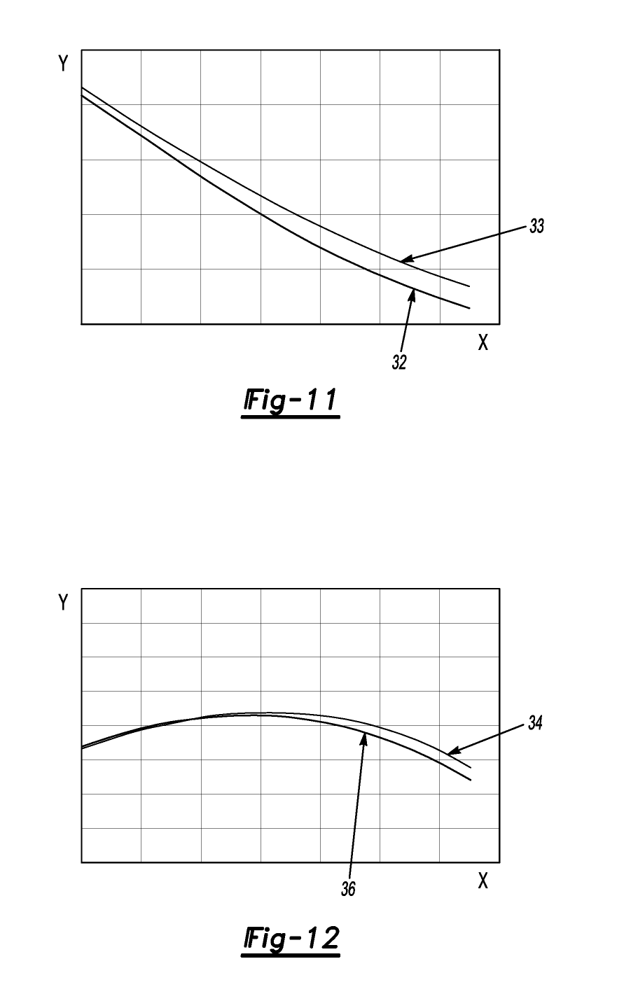

FIG. 7 shows that the coil spring produces or absorbs lateral forces through the tilted line of action of force 9 according to the invention, counteracting the lateral forces of the wheels. Once again, the X axis represents the wheel travel, and the Y axis represents the lateral forces of the coil springs. Graph line 21 shows the lateral forces of the coil spring for the wheel on the outside of the bend (inward deflection). Graph line 22 shows the lateral forces of the coil spring for the wheel on the inside of the bend (outward deflection). Graph line 23 shows the sum of the lateral forces of the coil spring.

Graph line 23 from FIG. 7 has been transferred to FIG. 8, showing that the coil spring absorbs lateral forces and reduces the load on the structural elements of the rear wheel suspension by about 30% (with respect to graph line 19 on graph line 23) since the lateral forces of the coil spring oppose the lateral forces of the wheels. This is achieved in a simple manner if the line 9 of action of the coil spring 7 on the outside of the bend (inward deflection, FIG. 6) has a more pronounced tilt than on the inside of the bend (outward deflection, FIG. 5). This means that the coil spring 7 relieves the structural components of the rear wheel suspension or semi-independent axle of 30% of the total load which would have to be borne by structural components of a known semi-independent axle.

Thus, FIGS. 7 and 8 show that a higher lateral spring force is generated on the outside of the bend than on the inside of the bend because of the opposed tilt of the line of action of force 9. The load on the structural components can be reduced by 30%. This effect can be further increased if a geometric coil spring tilt is added to the combination.

The graph line 23 in FIG. 8, which is shifted in the direction of the X axis in relation to FIG. 7, results from the fact that the scale along the Y axis is different in FIG. 8 to that in FIG. 7. Moreover, the point of intersection of graph line 23 with the Y axis at zero in FIG. 7 is clearly above the X axis, while the zero point in FIG. 8 is the point of intersection between the X axis and the Y axis.

FIGS. 9 and 10 represent the wheel travel (X axis) against a transverse offset (Y axis) of a semi-independent axle according to the prior art in comparison with the semi-independent axle according to the invention. The inside and the outside of the bend are plotted in FIG. 9. The sum formed in each case is represented in FIG. 10.

Graph line 24 (FIG. 9) shows a transverse offset at the outside of the bend for the known semi-independent axle, while graph line 26 shows a transverse offset at the inside of the bend for the latter. Similarly, graph line 27 shows a transverse offset at the outside of the bend for the semi-independent axle according to the invention, while graph line 26 shows a transverse offset at the inside of the bend for the latter. It is apparent that smaller amounts of transverse offset are already achieved on the inside of the bend and on the outside of the bend with the semi-independent axle according to the invention than with the known semi-independent axle. This is continued in the sums formed, as FIG. 10 shows. Graph line 29 shows the sum of the transverse offset of the known semi-independent axle, while graph line 31 shows the sum of the transverse offset of the semi-independent axle according to the invention.

With the semi-independent axle according to the invention, a reduction of 14% on the outside of the bend and a reduction of 33% on the inside of the bend is achieved, and, in sum (FIG. 10), a reduction of 20% (FIG. 10) is thereby achieved. In other words, the semi-independent axle according to the invention is improved in its compliance, with the result that the vehicle responds more directly and a ride with a “spongy” feel is at least reduced without the need to provide additional components.

FIG. 11 shows the action of the semi-independent axle according to the invention on a toe-out effect (arrow), which is reduced by 10% relative to the known semi-independent axle. The X axis represents the wheel travel, and the Y axis represents the toe in °. Graph line 32 shows the toe-out of the known semi-independent axle, while graph line 33 shows the toe-out of the semi-independent axle according to the invention. It is apparent that the toe-out effect of the semi-independent axle according to the invention is reduced by 10%.

FIG. 12 represents the effect of the semi-independent axle according to the invention with respect to camber (graph line 34) compared with the known semi-independent axle (graph line 36). The X axis represents the wheel travel, and the Y axis represents the camber in °. It is apparent that a somewhat improved effect in terms of reduced negative camber can be produced owing to the reduced vertically acting force on the spring seat in order to produce a counter torque.

Of course, the amounts mentioned and the numbers quoted are only examples and should in no way be taken to have a limiting effect.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A rear wheel suspension, comprising:
a spring that has a line of action of force disposed along a spring center line; and
an upper and a lower spring mount supporting the spring, wherein the spring is arranged with the line of action of force being tilted during an inward deflection to a different extent than the line of action of force is tilted during an outward deflection.

2. The rear wheel suspension as claimed in claim 1, wherein the line of action of force has an upper piercing point and a lower piercing point, which are arranged opposite in relation to the spring center line when the spring is deflected inward or outward.

3. The rear wheel suspension as claimed in claim 2, wherein in relation to the lower piercing point of the line of action of force through a lower spring mount, the upper piercing point of the line of action of force through an upper spring mount is arranged closer to the spring center line than the lower piercing point.

4. The rear wheel suspension as claimed in claim 1, wherein:
a first lateral force produced by the spring;
a second lateral force produced by the wheels, wherein the first lateral force is directed counter to the second lateral force when the spring is deflected inward or outward.

5. The rear wheel suspension as claimed in claim 1, wherein the amount of tilt of the line of action of force during an inward deflection is greater than in the case of an outward deflection.

6. The rear wheel suspension as claimed in claim 1, wherein the spring is mounted with a tilt between the upper and the lower spring mount.

7. The rear wheel suspension as claimed in claim 1, wherein the respective line of action of force of each spring of the rear wheel suspension has an oppositely oriented tilt, preferably of the same magnitude, when the spring is not being deflected either inward or outward.

8. The rear wheel suspension as claimed in claim 1 further comprising a semi-independent axle of a motor vehicle.

9. The rear wheel suspension as claimed in claim 1, further comprising an upper guide element that engages an outer circumference of the spring.

10. The rear wheel suspension as claimed in claim 1, further comprising a lower guide element that engages an outer circumference of the spring.

11. The rear wheel suspension as claimed in claim 1, wherein the upper lower spring mount is set at an angle.

12. The rear wheel suspension as claimed in claim 1, wherein the lower spring mount is set at an angle.
